(19) United States
(12) Patent Application Publication
(10) Pub. No.: US 2020/0369230 A1
(43) Pub. Date: Nov. 26, 2020

(54) SHOCK-ABSORBING SYSTEM FOR A MOTOR VEHICLE

(71) Applicant: COMPAGNIE PLASTIC OMNIUM, Lyon (FR)

(72) Inventors: Stéphane GINJA, AMBERIEU EN BUGEY (FR); Thierry ROUSSEL, MONTESSON (FR); Anthony CHENE, JUJURIEUX (FR)

(21) Appl. No.: 16/473,765

(22) PCT Filed: Dec. 8, 2017
(86) PCT No.: PCT/FR2017/053455

§ 371 Date: Jun. 26, 2019

(30) Foreign Application Priority Data
Dec. 29, 2016 (FR) 1663534

(51) Int. Cl. B60R 19/34; B60R 19/18

(52) U.S. Cl. CPC B60R 19/34; F16F 7/12; B60R 19/18

(57) ABSTRACT

The invention relates to a shock-absorbing system (10) for a motor vehicle, intended to be interposed between a side member (20) and a transverse impact beam (30), characterised in that it comprises:
an absorbing element (40) that is able to irreversibly disintegrate at least partially in reaction to an impact,
a connecting element (50) comprising at least one wall (60) having an end intended to be secured to the beam (30) and another end intended to be secured to the side member (20), the wall (60) having a programmed zone of mechanical weakness that allows the wall (60) to fold in the event of an impact.

This invention relates to the field of bumpers, more particularly energy absorption systems such as shock-absorbers for a motor vehicle.

Absorbers for a motor vehicle intended to be interposed between a transverse impact beam and side members which connect the assembly to the vehicle body are already known in the prior art. They may be fitted at the front and/or at the rear of the vehicle, extending in the longitudinal direction. Such absorbers absorb energy in the event of an impact in order to limit the deformation of other components and the repair costs.

Currently, car manufacturers are increasingly trying to reduce the energy consumption of motor vehicles, especially by reducing their weight. In this perspective, they try to reduce the size of the bumpers, in particular that of the beam and of the absorbers in the longitudinal direction. At the front of the vehicle, a 50 mm reduction in the distance between the front of the beam and the rear of the absorbers lightens the vehicle by about 5 kg. This distance reduction induces a reduction in the vehicle overhang, which also brings greater freedom of vehicle style, especially with more vertical bumpers and shorter bonnets.

However, the reduction of this distance (between the front of the beam and the rear of the absorbers), and therefore the overhang, is limited by safety standards which require satisfactory strength for the bumper and the surrounding parts. One way of reducing the overhang is to increase the efficient length of the absorber, in other words the distance over which the absorber deforms before reaching its incompressibility, characterised by a large increase in force. In the context of this invention, compressibility is understood to mean the ability of a body to be crushed considerably, in other words to leave an incompressible residue that is as small as possible, for an equivalent quantity of absorbed energy (given in the specifications).

By way of example, a metal absorber can be compressed by about 75% and has an incompressibility of about 25%. The aim is therefore to increase the compressibility of the absorbers so that they can absorb as much energy as much as possible in the event of an impact in a reduced axial space. This axial space is therefore the total of the crushing distance (during which energy is absorbed), and the incompressible residue remaining at the end. In other words, the aim is to reduce the incompressible portion of the absorbers which does not contribute to energy absorption.

An absorber of an impact beam made of composite material is known, in which the absorber consists of two shells each integrated in a connecting element. The way these half-shells are connected together implies a progressive folding type deformation of the absorber favoured by the discontinuous connection of these two half-shells (screws, rivets, etc.) and by initiation which takes place between these connecting points (energy absorption by deformation of successive waves of the half-shells). “Progressive folding” (known by the specialists) is less efficient than delamination in terms of energy absorption since it creates an incompressible residue after an impact (approximately 25%). With a delamination mode, an incompressible residue of about 5% may be achieved. This reduction of the incompressible residue induces an increase in the efficient length of the absorber and therefore a greater energy absorption potential for an identical force calibration.

Initiation which is not carried out at the front of the absorber is not optimum for the energy absorption.

In addition, since these connecting elements are by definition rigid, they induce non-compressible areas around themselves which increase the incompressible residue after an impact. The multiplication of these connections amplifies this phenomenon.

Energy absorbing systems based on axial compression of a composite tube are also known. Conventionally, this tube consists of a resin forming the matrix of the composite and the fibres.

To favour energy efficiency, continuous fibres stacked across the thickness of the tube are used. The stack may consist of one or more reinforcements, oriented unidirectionally (UD fibres) or in different orientations (for example) 0°/+45°/−45°/0°).

The continuous fibres known include in particular UDs, stitched biaxial reinforcements, woven reinforcements, mats which are used in particular in the pultrusion method. Reinforcement using tapes oriented substantially at +/−45° as described in patent U.S. Pat. No. 6,601,886B1 is also known.

The mode recommended for axial deformation of such a composite tube during the compression phase under a force (impact) is delamination. During such delamination, the fibre reinforcements shear across their thickness over the (entire) length of the tube.

In particular, patent U.S. Pat. No. 4,336,868A is known, which describes methods for manufacturing a composite tube and the performance of matrices and fibre reinforcements in terms of energy absorption capacity (specific absorption energy). This document illustrates in particular the tube delamination mode under an axial compression force.

Conventionally, the resin is reduced to dust and the various reinforcement layers are delaminated in the direction of the impact (therefore mainly “axial”), and thus absorb energy.

Initiation modes are also known to generate delamination by compression of a composite tube which consist in creating a weakness locally on the tube to initiate its deformation. Conventionally, a shape discontinuity such as a notch or a chamfer located at one end of the tube is used as initiation area. This discontinuity will be called the initiator.

The invention aims to remedy these disadvantages by providing a shock-absorbing system of reduced size, offering the vehicle good impact resistance. This absorbing system has a minimum incompressible residue while having maximum energy efficiency in order to reduce the vehicle overhang.

Thus, the invention relates to a shock-absorbing system for a motor vehicle, intended to be interposed between a side member and a transverse impact beam, characterised in that it comprises:
an absorbing element that is able to irreversibly disintegrate (as much as possible) at least partially in reaction to an impact, this destruction being delamination for example,
a connecting element comprising at least one wall having an end intended to be secured to the beam and another end intended to be secured to the side member, the wall having a programmed zone of mechanical weakness that allows the wall to fold in the event of an impact.

The term “delamination” is understood to mean the property of a body to shear across its longitudinal thickness. Delamination of the absorbing element causes irreversible destruction of at least a large portion of the absorbing element such that it no longer consists of a single piece. Thus, the compressibility of the absorbing element is significantly increased. The length required by the shock-absorbing system is therefore reduced, helping to reduce the overhang and lighten the vehicle considerably. Such an absorbing element can achieve a compressibility of more than 90% (corresponding to an incompressible residue of less than 10%) compared with an aluminium absorber having a compressibility of about 75%.

The presence of the connecting element holds, secures the beam to the side member, in particular after disintegration of at least a portion of the absorbing element after an impact. It does not participate or participates only very slightly (less than 10%) in the energy absorption and its thickness after an impact (called its incompressible residue) is lower than that of the absorbing element so that the absorbing element can compress up to its maximum compressibility without being affected by the connecting element. The presence of a programmed zone of mechanical weakness allows the connecting element to initiate the absorbing element compression mode in the event of an impact, for example by folding at the programmed zone of mechanical weakness, and to follow the absorbing element compression movement.

A “programmed zone of mechanical weakness” is understood to mean a zone where the mechanical strength of the material is weakened so as to initiate and direct the folding of the mechanical part when it is subjected to a force.

The absorber according to the invention may further comprise the following characteristics, taken alone or in combination:
the absorbing element is able to disintegrate by delamination;
the absorbing element is positioned inside the connecting element, the programmed zone of mechanical weakness being planned such that the wall of the connecting element folds, for example towards the outside with respect to the absorbing element; the assembly formed by the absorbing element and the connecting element is therefore compact, thereby helping to save space;
the programmed zone of mechanical weakness comprises a pre-fold, a slit or a thickness reduction;
the absorbing element is a hollow body, preferably a tube having a cross-section selected from the following list: circular, rectangular, conical, hexagonal, scalable;
the absorbing element does not consist of an assembly of different parts;
the absorbing element comprises at least one layer of composite material having a plastic matrix and reinforcement elements; the composite materials give the absorbing element high compressibility, thereby reducing the overhang of the bumper;
the matrix is a thermoplastic material, preferably selected from the following materials: polyamide, polypropylene, polyurethane;
the matrix is a thermosetting material, preferably selected from the following materials: epoxy, polyester, vinyl ester;
the reinforcement elements are continuous fibres, preferably based on a material selected alone or in combination from the following materials: carbon, glass, aramid;
the reinforcement elements are unidirectional fibres oriented in a direction not parallel to a longitudinal direction of the vehicle;
the reinforcement elements are biaxial (fabrics, NCF, mat);
the continuous reinforcement elements are made by combining and stacking unidirectional and biaxial reinforcements or several biaxial reinforcements;
the continuous reinforcement elements are triaxial: 3D sock manufactured using the braiding method or by assembling biaxial reinforcements in different planes;
the absorbing element comprises internal ribs;
the absorbing element is manufactured by pultrusion, reactive pultrusion or by extrusion;
the connecting element has an incompressibility rate of less than 5% after an impact; in addition, by folding along the programmed zone of mechanical weakness, the connecting element increases the impact resistance of the beam in the longitudinal direction.

The invention also relates to an assembly of an impact beam, a side member and at least one shock-absorbing system according to the invention, the shock-absorbing system being secured respectively to the beam and to the side member by attachment plates. Advantageously, the shock-absorbing system is inserted in the plates outside the compression area, so as not to generate an incompressible residue between the two plates.

The invention also relates to a method for assembling an assembly according to the invention, comprising the following steps:
mounting on the connecting element the attachment plate for securing the shock-absorbing system to the beam;
arranging the absorbing element inside the connecting element;
mounting on the connecting element the attachment plate for securing the shock-absorbing system to the side member;
securing the side member to the shock-absorbing system; and
securing the shock-absorbing system to the beam.

The invention also relates to an impact beam, comprising at least one shock-absorbing system according to the invention.

The invention also relates to a motor vehicle front module comprising at least one shock-absorbing system according to the invention.

The invention also relates to a motor vehicle comprising at least one shock-absorbing system according to the invention.

The invention will be better understood on reading the accompanying figures, which are given solely by way of example and not limiting in any way, in which:

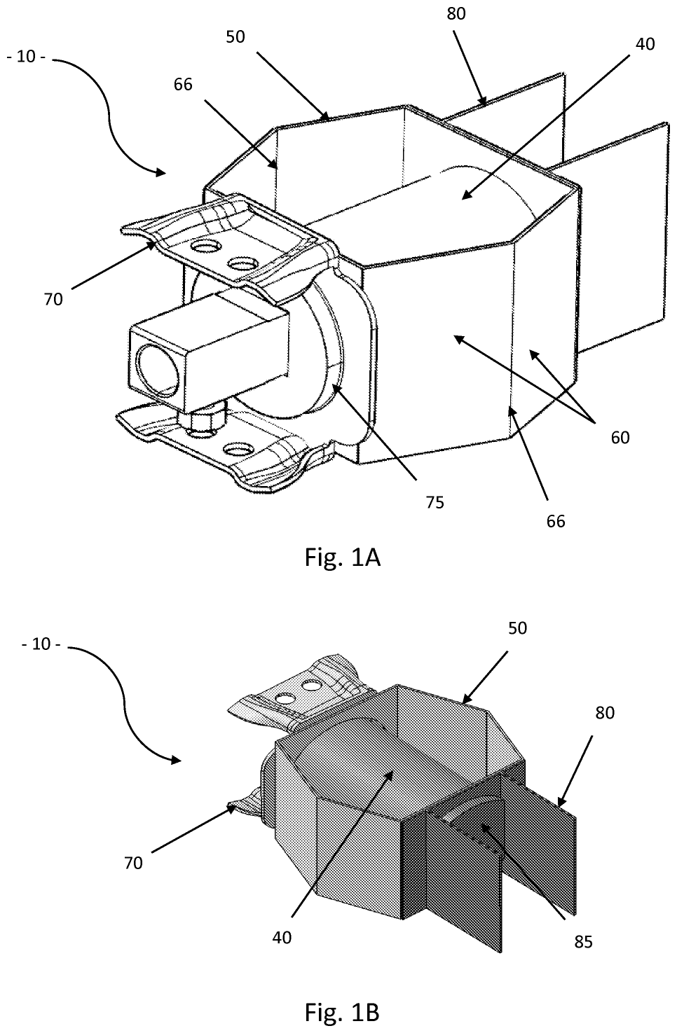

FIGS. 1A and 1B show a shock-absorbing system according to one embodiment of the invention; FIG. 1A shows the portion intended to be secured to the beam, and FIG. 1B shows the portion intended to be secured to the side member;

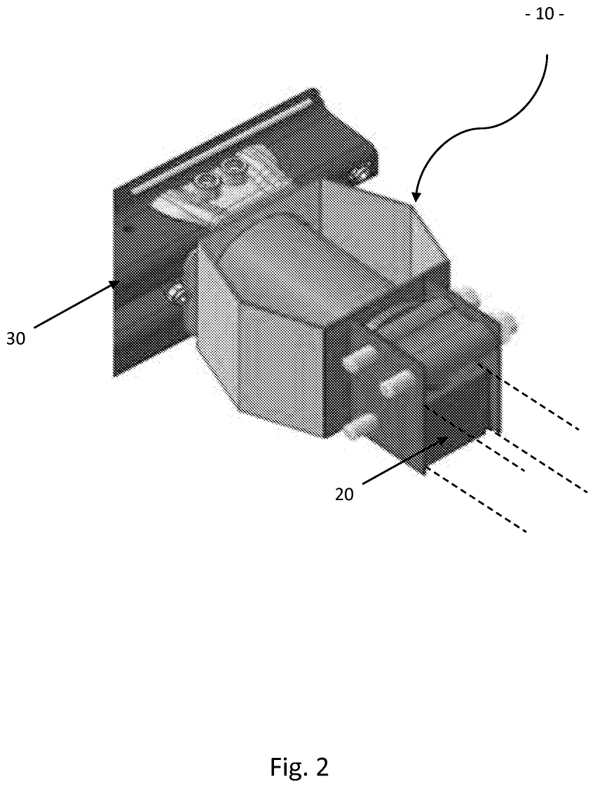

FIG. 2 shows an assembly of a beam, side members and a shock-absorbing system of FIG. 1; and

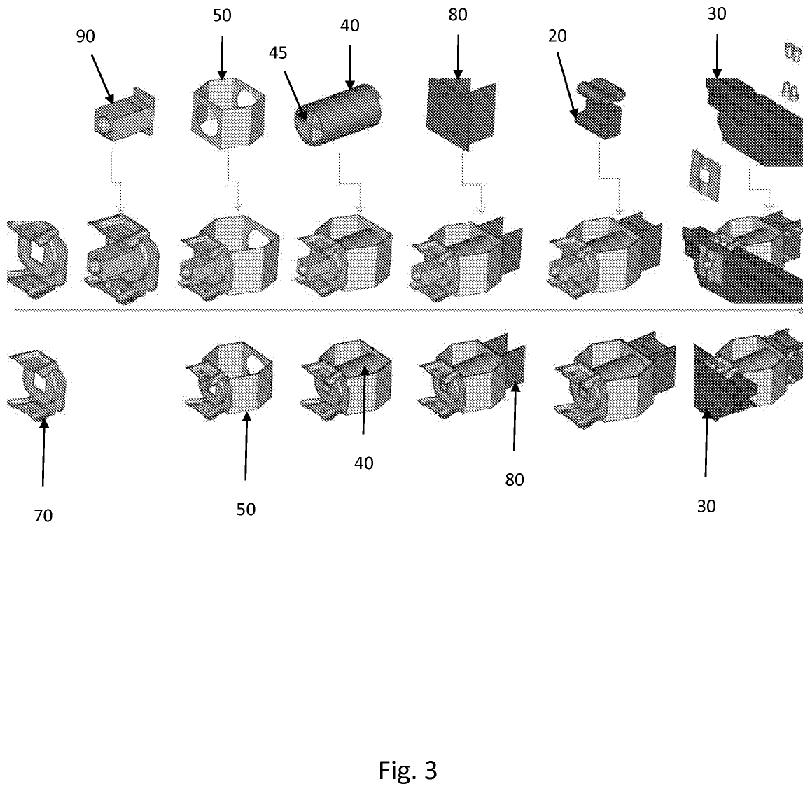

FIG. 3 shows various steps of assembling an assembly of FIG. 2.

We now refer to FIGS. 1A, 1B and 2 which show an example of a shock-absorbing system 10 for a motor vehicle according to the invention. This system 10 is intended to be interposed between a side member 20 and a transverse impact beam 30. It comprises:
an absorbing element 40 that is able to irreversibly disintegrate at least partially in reaction to an impact, for example by delamination;
a connecting element 50, intended to be connected to the side member 20 and to the impact beam 30, comprising at least one wall 60 having an end intended to be secured to the beam 30 and another end intended to be secured to the side member 20, the wall 60 having a programmed zone of mechanical weakness 66 that allows the wall 60 to fold in the event of an impact.

According to one embodiment, the impact beam absorber is configured so that the initiator is on the side of the bar, such that the absorber compresses substantially longitudinally from the bar towards the side members (direction X in the vehicle coordinate system). The initiator is therefore preferably located towards the front of the tube, more preferably at its end so that delamination occurs from the front towards the rear.

### The Absorbing Element 40

According to one embodiment, the absorbing element 40 is a hollow body, preferably a tube having a cross-section selected from the following list: circular, rectangular, conical, hexagonal, scalable.

Advantageously, the absorbing element 40 is made in one piece, in other words it is not manufactured by assembling different parts. It may, for example, be manufactured by moulding composite material, in particular by reactive pultrusion or by extrusion.

According to one embodiment, the absorbing element 40 comprises at least one layer of composite material having a plastic matrix and reinforcement elements.

The plastic matrix is, for example, a thermoplastic material, preferably selected alone or in combination from the following materials: polyamide, polypropylene, polyurethane.

The plastic matrix may alternatively be a thermosetting material, preferably selected alone or in combination from the following materials: epoxy, polyester, vinyl ester.

The reinforcement elements may be continuous fibres, preferably based on a material selected alone or in combination from the following materials: carbon, glass, aramid.

The reinforcement elements are preferably unidirectional fibres oriented in a direction not parallel to a longitudinal direction of the vehicle.

Advantageously, the absorbing element 40 comprises internal ribs 45.

According to an example shown on FIGS. 1A and 1B, the absorbing element 40 advantageously consists of a composite tube with continuous reinforcements, continuously connected at the front to the bar of the impact beam 30 and at the rear to the side member 20 or to the plate of the side member 20.

The absorbing element 40 comprises, at its end intended to be positioned on the side of the beam 30, an initiator which initiates delamination by compression of the absorbing element 40 from the front towards the rear (in the direction of the impact), and which deforms according to a delamination mode. This tube is able to delaminate over substantially its entire length.

According to one embodiment, shown on FIGS. 1A to 3, the absorbing element 40 is positioned inside the connecting element 50, the programmed zone of mechanical weakness 66 being planned so that the wall of the connecting element folds, for example, towards the outside of the connecting element 50.

The programmed zone of mechanical weakness 66 comprises a pre-fold, a slit or a thickness reduction.

### The Connecting Element 50

The connecting element 50, between the impact beam 30 and the side member 20, forms a guiding system not continuously connected to the absorbing element 40 (composite tube on the figures). One of its functions is to guide the absorbing element 40 during its compression in the event of an impact, without however contributing to energy absorption. It allows a connection after an impact between the bar of the impact beam 30 and the side member 20 of the vehicle. It has the ability to deform, in particular due to the programmed zone of mechanical weakness 66, and not generate an incompressible residue after total compression.

Advantageously therefore, the connecting element 50 has an incompressibility rate of less than 5% after an impact.

The invention also relates to an assembly of an impact beam 30, a side member 20 and at least one shock-absorbing system 10 according to the invention.

The shock-absorbing system 10 is secured to the impact beam 30 by an attachment plate 70, and to the side member 20 by an attachment plate 80.

The plates 70 and 80 comprise recesses 75 and 85, or housings, to accommodate, for example by insertion, the tube forming the absorbing element 40.

To avoid generating an incompressible residue between the two plates 70 and 80, the tubes (absorbing element 40) are inserted in the plates 70 and 80 outside the compression area (see FIGS. 1A and 1B). During a compression after an impact in fact, one side of the plate 70 may come into contact with one side of the plate 80. As shown on FIGS. 1A and 1B, the entire portion of the absorbing element 40 between these two sides will be delaminated.

The invention also relates to a method for assembling such an assembly comprising the following steps (FIG. 3):
mounting on the connecting element 50 the attachment plate 70 for securing the shock-absorbing system 10 to the beam 30;
arranging the absorbing element 40 inside the connecting element 50;
mounting on the connecting element 50 the attachment plate 80 for securing the shock-absorbing system 10 to the side member 20;
securing the side member 20 to the shock-absorbing system 10; and
securing the shock-absorbing system 10 to the beam 30.

FIG. 3 also shows a step of securing a towing system 90.

The invention also relates to an impact beam 30, comprising at least one shock-absorbing system 10 according to the invention.

The invention also relates to a motor vehicle front module comprising at least one shock-absorbing system 10 according to the invention.

The invention also relates to a motor vehicle comprising at least one shock-absorbing system 10 according to the invention.

### LIST OF REFERENCES

10: shock-absorbing system
20: side member of the motor vehicle
30: transverse impact beam of the motor vehicle
40: absorbing element of the shock-absorbing system 10
45: internal ribs of the absorbing element 40
50: connecting element, of the shock-absorbing system 10, between the impact beam 30 and the side member 20
60: wall of the connecting element 50
66: programmed zone of mechanical weakness of the wall 60
70: attachment plate for securing the shock-absorbing system 10 to the impact beam 30
75: recesses of the attachment plate 70
80: attachment plate for securing the shock-absorbing system 10 to the side member 20
85: recesses of the attachment plate 80
90: towing system

1. Shock-absorbing system (10) for a motor vehicle, intended to be interposed between a side member (20) and a transverse impact beam (30), characterised in that it comprises:
an absorbing element (40) that is able to irreversibly disintegrate at least partially in reaction to an impact;
a connecting element (50) comprising at least one wall (60) having an end intended to be secured to the impact beam (30) and another end intended to be secured to the side member (20), the wall (60) having a programmed zone of mechanical weakness (66) that allows the wall (60) to fold in the event of an impact.

2. Shock-absorbing system (10) according to the preceding claim, wherein the absorbing element is able to disintegrate by delamination.

3. Shock-absorbing system (10) according to one of the preceding claims, wherein the absorbing element (40) comprises, at its end intended to be positioned on the side of the beam (30), an initiator which initiates delamination by compression of the absorbing element (40) in the direction of the impact.

4. Shock-absorbing system (10) according to one of the preceding claims, wherein the absorbing element (40) is able to delaminate over its entire length.

5. Shock-absorbing system (10) according to one of the preceding claims, wherein the absorbing element (40) is positioned inside the connecting element (50).

6. Shock-absorbing system (10) according to one of the preceding claims, wherein the programmed zone of mechanical weakness (66) comprises a pre-fold, a slit or a thickness reduction.

7. Shock-absorbing system (10) according to one of the preceding claims, wherein the absorbing element (40) is a hollow body, preferably a tube having a cross-section selected from the following list: circular, rectangular, conical, hexagonal, scalable.

8. Shock-absorbing system (10) according to one of the preceding claims, wherein the absorbing element (40) does not consist of an assembly of different parts.

9. Shock-absorbing system (10) according to one of the preceding claims, wherein the absorbing element (40) comprises at least one layer of composite material having a plastic matrix and reinforcement elements.

10. Shock-absorbing system (10) according to the preceding claim, wherein the matrix is a thermoplastic material, preferably selected from the following materials: polyamide, polypropylene, polyurethane.

11. Shock-absorbing system (10) according to claim 9, wherein the matrix is a thermosetting material, preferably selected from the following materials: epoxy, polyester, vinyl ester.

12. Shock-absorbing system (10) according to one of claims 9 to 11, wherein the reinforcement elements are continuous fibres, preferably based on a material selected alone or in combination from the following materials: carbon, glass, aramid.

13. Shock-absorbing system (10) according to one of claims 9 to 12, wherein the reinforcement elements are unidirectional fibres oriented in a direction not parallel to a longitudinal direction of the vehicle.

14. Shock-absorbing system (10) according to one of the preceding claims, wherein the absorbing element (40) comprises internal ribs (45).

15. Shock-absorbing system (10) according to one of the preceding claims, wherein the absorbing element (40) is manufactured by reactive pultrusion or by extrusion.

16. Shock-absorbing system (10) according to one of the preceding claims, wherein the connecting element (50) has an incompressibility rate of less than 5% after an impact.

17. Assembly of a beam (30), a side member (20) and a shock-absorbing system (10) according to any one of the preceding claims, characterised in that the shock-absorbing system (10) is secured respectively to the beam (30) and to the side member (20) by attachment plates (70, 80).

18. Assembly according to the preceding claim, wherein the shock-absorbing system (10) is inserted in the plates (70, 80) outside the compression area, so as not to generate an incompressible residue between the two plates (70 and 80).

19. Impact beam (30), characterised in that it comprises at least one shock-absorbing system (10) according to one of claims 1 to 16.

20. Motor vehicle front module, characterised in that it comprises at least one shock-absorbing system (10) according to one of claims 1 to 16.

21. Motor vehicle, characterised in that it comprises at least one shock-absorbing system (10) according to one of claims 1 to 16.

22. Method for assembling an assembly according to claim 17 or 18, characterised in that it comprises the following steps:
mounting on the connecting element (50) the attachment plate (70) for securing the shock-absorbing system (10) to the beam (30);
arranging the absorbing element (40) inside the connecting element (50);
mounting on the connecting element (50) the attachment plate (80) for securing the shock-absorbing system (10) to the side member (20);
securing the side member (20) to the shock-absorbing system (10); and
securing the shock-absorbing system (10) to the beam (30).
